(19) United States
(12) Patent Application Publication
(10) Pub. No.: US 2003/0205214 A1
(43) Pub. Date: Nov. 6, 2003

(54) Typhoon

(76) Inventor: Marvin Rex Lord, Lexington, TN (US)

Correspondence Address: REX LORD, 100 MEADOWLARK LN., LEXINGTON, TN, 38351, US

(21) Appl. No.: 10/138,906

(22) Filed: May 6, 2002

(51) Int. Cl. F02B 31/00

(52) U.S. Cl. 123/306

(57) ABSTRACT

A throttle body spacer (FIG. 1) with Six (6) rapid twisting slots (radius) (FIG. 2-3) the six (6) equally spaced rapid twisting slots maintaining a constant radial slot depth having a pitch of 0.5 (½) per 1 inch on a 1.0 inch thick spacer, and 0.375 (⅜) per 1 inch on a 0.75 inch thick spacer, the rapid twisting slot is a combination of three (3) radius (FIG. 3) this is accomplished by using a 90 degree dove tail tool with a 0.046 radius on the corner in conjunction with the ½ and ⅜ pitch slots, the bottom edge of the slots is extended into the tapered bore from top to bottom allowing it to grab the incoming air, this causes a vortex of air for better fuel atomization giving the engine more horsepower, torque and improved gas mileage.

### SUMMARY

This invention for throttle body spacer that fits between the throttle body and the intake manifold of internal combustion engines is designed to improve performance and fuel economy with a tapered bore and equally spaced rapid twisting ridge/slots tapered from top of the spacer block to bottom same as bore taper maintaining a constant radial slot depth having a pitch of 0.5 (½) per 1 inch on a 1.0 inch thick spacer, and 0.375 (⅜) per 1 inch on a 0.75 inch thick spacer, the top of the throttle body spacer has a ¼ radius that blends into the bore, the rapid twisting ridge/slots is a combination of three (3) radius this is accomplished be using a 90° degree dove tail tool with a 0.046 radius on the corner in conjunction with the ½ and ⅜ pitch ridge/slots, the bottom edge of the slot is extended into the tapered bore from top to bottom allowing it to deflect the incoming air, which causes a vortex of air for better fuel atomization giving the engine more horsepower, torque and improved gas mileage.

### DESCRIPTION OF DRAWINGS

FIG. 1 View of throttle body spacer block showing a solid top, bottom, side section, front section, and isometric views.

FIG. 2 Two wire frame views showing ¼ radius and equally spaced rapid twisting ridge/slots.

FIG. 3 A front sectional view showing ridge/slot configuration and dimensions.

FIG. 4 A front sectional view showing ridge/slot configuration.

FIG. 5 A front sectional view showing the 20° degree included angle of the bore.

FIG. 6 A front sectional view showing the 12° degree included angle of the bore.

FIG. 7 A front sectional view showing a straight bore.

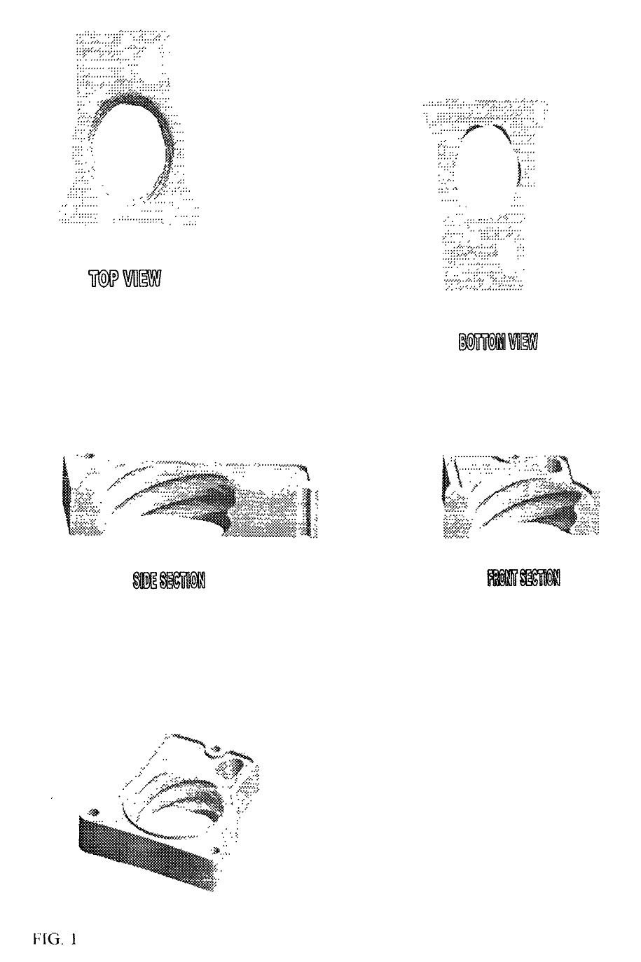

### DESCRIPTION

The throttle body spacer block is made from flat aluminum bars that will vary in thickness depending on the application from 1.0 thick to 0.75 thick. The out side profile of the throttle body will change to fit the application and hole pattern of different engines. The tapered bore and equally spaced rapid twisting slots, tapered from top of the spacer block to bottom same as bore taper maintaining a constant radial slot depth having a pitch of 0.5 (½) per 1 inch on a 1.0 inch thick spacer, and 0.375 (⅜) per 1 inch on a 0.75 inch thick spacer, the top of the throttle body spacer has a ¼ radius that blends into the bore, the rapid twisting ridge/slot is a combination of three (3) radius this is accomplished be using a 90° degree dove tail tool with a 0.046 radius on the corner in conjunction with the ½ and ⅜ pitch slots, the bottom edge of the slot is extended into the tapered bore from top to bottom allowing it to deflect the incoming air, this causes a vortex.

Operation

This invention as per defined with its special designed twisting ridge/slots, creates a vortex of air that enhances fuel atomization. The accelerated airflow improves performance by increasing horsepower and torque. The described applications for this invention can be used in engines of automobiles, boats, motorcycles, jet ski, atv's, and planes.

1. The TBI, TPI, and carburetor spacer block that installs between the throttle body and intake manifold is designed to creates a typhoon-like air funnel that enhances fuel atomization and improves fuel economy, accelerated air flow improves performance, drive ability, and throttle response with any grade of fuel, which is achieved by the use of a rapid twisting slot design, better airflow creates more horsepower and torque throughout the entire R.P.M. band, application include cars, trucks, boats, motorcycles, and planes

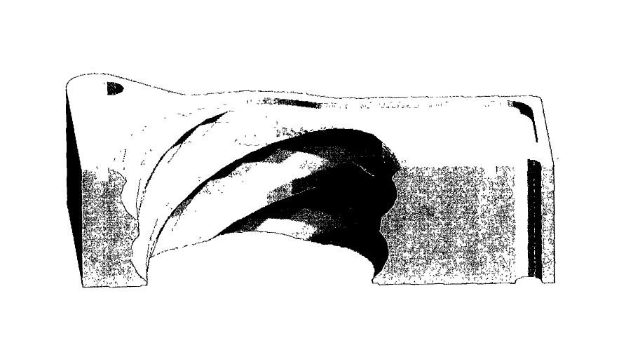

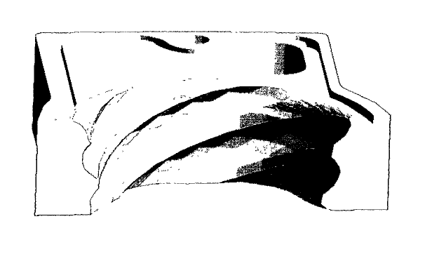

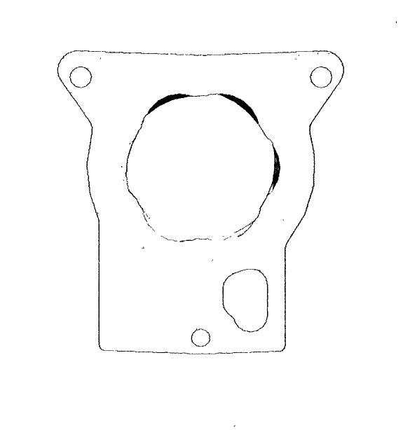

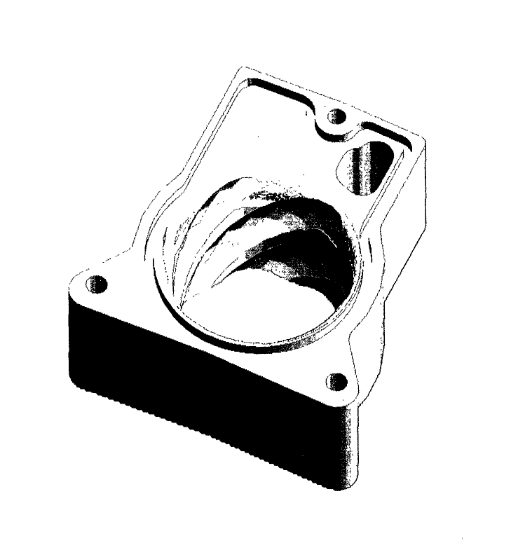

2. A typhoon design for throttle body spacer consist of a ten (10°) degree per side tapered bore from the top of the block to the bottom with six (6), five (5), four (4), three (3) or two (2) (depending on engine in which to install) equally spaced rapid twisting slots cut into the side of the bore maintaining a constant radial depth to the bore following the same ten (10°) degree bore from top to bottom using a 0.5 (½) pitch starting at the top of the block on a 1.0 inch spacer and ending at the bottom and a 0.375 (⅜) pitch starting at the top of the block on a 0.75 inch spacer and ending at the bottom. The top of the throttle body spacer has a ¼ radius that blends into the bore (FIGS. 2-3) the rapid twisting ridge/slot is a combination of three (3) radius (FIG. 3) this is accomplished be using a 90° degree dove tail tool with a 0.046 radius on the corner in conjunction with the ½ and ⅜ pitch ridge/slot, the bottom edge of the ridge/slot is extended into the tapered bore from top to bottom allowing it to deflect the incoming air, this causes a vortex of air for better fuel atomization giving the engine more horsepower, torque and improved gas mileage.

3. A typhoon design 2 for throttle body spacer consist of a six (6°) degree per side tapered bore from the top of the block to the bottom with six (6), five (5), four (4), three (3) or two (2) (dependent on engine in which to install) equally spaced rapid twisting slots cut into the side of the bore maintaining a constant radial depth to the bore following the same six (6°) degree bore from top to bottom using a 0.5 (½) pitch starting at the top of the block on a 1.0 inch spacer and ending at the bottom and a 0.375 (⅜) pitch starting at the top of the block on a 0.75 inch spacer and ending at the bottom. The top of the throttle body spacer has a ¼ radius that blends into the bore (FIG. 2-3) the rapid twisting ridge/slot is a combination of three (3) radius (FIG. 3) this is accomplished be using a 90° degree dove tail tool with a 0.046 radius on the corner in conjunction with the ½ and ⅜ pitch slots, the bottom edge of the ridge/slot is extended into the tapered bore from top to bottom allowing it to deflect the incoming air, this causes a vortex of air for better fuel atomization giving the engine more horsepower, torque and improved gas mileage.

4. A typhoon design 3 for throttle body spacer consist of a straight bore from the top of the block to the bottom with six (6), five (5), four (4), three (3) or two (2) (depending on engine in which to install) equally spaced rapid twisting slots cut into the side of the bore maintaining a constant radial depth to the bore following the straight bore from top to bottom using a 0.5 (½) pitch starting at the top of the block on a 1.0 inch spacer and ending at the bottom and a 0.375 (⅜) pitch starting at the top of the block on a 0.75 inch spacer and ending at the bottom. The top of the throttle body spacer has a ¼ radius that blends into the bore (FIG. 2-3) The rapid twisting ridge/slot is a combination of three (3) radius (FIG. 3) this is accomplished be using a 90° degree dove tail tool with a 0.046 radius on the corner in conjunction with the ½ and ⅜ pitch ridge/slot, the bottom edge of the ridge/slot is extended into the tapered bore from top to bottom allowing it to deflect the incoming air, this causes a vortex of air for better fuel atomization giving the engine more horsepower, torque and improved gas mileage.
